(19) United States
(12) Patent Application Publication
(10) Pub. No.: US 2024/0311635 A1
(43) Pub. Date: Sep. 19, 2024

(54) TRAINING METHOD, TRAINING SYSTEM, AND NON-TRANSITORY COMPUTER READABLE RECORDING MEDIUM STORING TRAINING PROGRAM

(71) Applicant: Panasonic Intellectual Property Corporation of America, Torrance, CA (US)

(72) Inventors: Kunio NOBORI, Osaka (JP); Satoshi SATO, Kyoto (JP); Shunsuke YASUGI, Osaka (JP); Yusuke KATO, Osaka (JP)

(21) Appl. No.: 18/675,806

(22) Filed: May 28, 2024

Related U.S. Application Data
(63) Continuation of application No. PCT/JP2022/043630, filed on Nov. 25, 2022.

(30) Foreign Application Priority Data
Nov. 30, 2021 (JP) 2021-193790

(51) Int. Cl. G06N 3/08; G06V 10/776; G06V 10/82

(52) U.S. Cl. CPC G06N 3/08; G06V 10/776; G06V 10/82

(57) ABSTRACT

The training system determines a plurality of sensor parameter candidates to be used for an operation of a sensor, generates a plurality of sensor data sets corresponding to each of the plurality of sensor parameter candidates and including sensor data to be obtained by the operation of the sensor and a plurality of pieces of correct answer identification information corresponding to each of the sensor data, generates a plurality of trained neural network model candidates corresponding to the plurality of sensor parameter candidates, calculates identification performance of the plurality of trained neural network model candidates, selects a pair of the trained neural network model candidate with the highest identification performance and the sensor parameter candidate corresponding to the trained neural network model candidate with the highest identification performance, and outputs the selected pair of the sensor parameter candidate and the trained neural network model candidate.

### FIELD OF INVENTION

The present disclosure relates to, in an identification system using machine learning and the like, technology to optimize sensor parameters used for the operation of a data input sensor such as a camera, and a neural network model for identifying data obtained from the sensor.

### BACKGROUND ART

In automated vehicles and robots, technology to identify surrounding objects and recognize the environment is important. In recent years, technology called deep learning has attracted much attention for object identification. Deep learning refers to machine learning using multi-layer neural networks, and can achieve higher-accuracy identification performance than conventional identification methods by using large amounts of training data. Image information is particularly useful for such object identification.

For example, Non-Patent Literature 1 discloses an identification system that significantly improves the conventional object identification performance by deep learning with image information as input. In such an identification system, a camera is widely used as a sensor to input the image information. Usually, when designing or capturing images with such a camera, for the purpose of being seen by people, a designer or photographer determines parameters that determine the structure, optical characteristics, and the operation of the camera (hereafter, these are collectively referred to as “sensor parameters”) such that, based on people's subjectivity toward the captured images, the subjectivity improves.

Therefore, it cannot be said that the sensor parameters of a normal camera are optimal if considered based on the identification performance of deep learning. Therefore, in recent years, for the purpose of improving the deep learning's identification performance, a method has been proposed to optimize sensor parameters based on the identification performance of deep learning.

For example, Patent Literature 1 discloses a sensing device that changes measurement parameters, such as the shutter speed, white balance, and gain, based on object identification accuracy information for the purpose of improving the identification performance of an object in an image captured by a camera.

For example, Non-Patent Literature 2 discloses that chromatic aberration or astigmatism, which is usually considered unnecessary in a normal camera, is important in deep learning for the purpose of depth estimation or three-dimensional object detection. This literature discloses, for the purpose of improving the accuracy of depth estimation from images captured by a camera, a method for optimizing sensor parameters such as chromatic aberration or astigmatism by formulating image formation of a camera as a differentiable model by using wave optics that can represent refraction or diffraction, and training this model and the neural network model for depth estimation by using error back propagation.

In addition, for example, Non-Patent Literature 3 discloses, for the purpose of improving the performance of action identification from spatiotemporal compressed sensing images, a technique to optimize compressed sensing patterns that are sensor parameters by representing spatiotemporal compressed sensing as an encoding network by deep learning and simultaneously learning compressed sensing patterns and identification models that are most suitable for action identification.

However, the conventional technology described above can lead to a decrease in the identification performance, and further improvements are needed.

Patent Literature 1: JP 2020-35443 A

Non-Patent Literature 1: A. Krizhevsky, I. Sutskever, G. E. Hinton, “ImageNet Classification with Deep Convolutional Neural Networks”, NIPS' 12:Proceedings of the 25th International Conference on Neural Information Processing Systems, Volume 1, December 2012, pp. 1097-1105

Non-Patent Literature 2: Julie Chang, Gordon Wetzstein, “Deep Optics for Monocular Depth Estimation and 3D Object Detection”, 2019 IEEE/CVF International Conference on Computer Vision (ICCV), 2019, pp. 10193-10202

Non-Patent Literature 3: Tadashi Okawara, Michitaka Yoshida, Hajime Nagahara, Yasushi Yagi, “Action Recognition from a Single Coded Image”, 2020 IEEE International Conference on Computational Photography (ICCP), 2020

### SUMMARY OF THE INVENTION

The present disclosure has been made to solve the above problems, and an object of the present disclosure is to provide technology to improve identification performance.

A training method according to the present disclosure is a training method in a computer, the training method including: determining a plurality of sensor parameter candidates that are candidates for sensor parameters to be used for an operation of a sensor; generating a plurality of sensor data sets corresponding to each of the plurality of sensor parameter candidates and including sensor data to be obtained by the operation of the sensor and a plurality of pieces of correct answer identification information corresponding to each of the sensor data; generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data; calculating identification performance of the plurality of trained neural network model candidates by using another sensor data of the sensor data included in the sensor data sets and the correct answer identification information corresponding to the other sensor data; selecting a pair of the trained neural network model candidate with the highest identification performance and the sensor parameter candidate corresponding to the trained neural network model candidate with the highest identification performance; and outputting the selected pair of the sensor parameter candidate and the trained neural network model candidate.

According to the present disclosure, both the sensor parameter used for the operation of the sensor and the trained neural network model for identifying the target from the sensor data obtained from the sensor can be optimized. With this configuration, since the sensor manufactured using the sensor parameter candidates to be output and the trained neural network model candidates to be output are used for the identification system, the identification performance in the identification system can be improved.

### BRIEF DESCRIPTION OF THE DRAWINGS

FIG. 1 is a block diagram showing one example of a configuration of a training system according to a first embodiment of the present disclosure.

FIG. 2 is a block diagram showing one example of a configuration of an identification system according to the first embodiment of the present disclosure.

FIG. 3 is a schematic diagram showing one example of structure of a multi-pinhole camera that acquires sensor data.

FIG. 4 is a schematic diagram showing one example of a multi-pinhole mask having a plurality of pinholes.

FIG. 5 is a diagram showing one example of a pinhole image.

FIG. 6 is a diagram showing one example of a multi-pinhole image.

FIG. 7 is a diagram showing one example of the multi-pinhole image in which the spacing between nine pinholes is wider than the spacing between nine pinholes in the multi-pinhole image shown in FIG. 6.

FIG. 8 is a flowchart for describing an operation of the training system in the present first embodiment.

FIG. 9 is a diagram showing one example of an image captured by a normal camera.

FIG. 10 is a diagram showing one example of an image representing the weight of PSF generated by the multi-pinhole mask corresponding to sensor parameter values that are input sensor parameter candidates.

FIG. 11 is a diagram showing one example of a pseudo multi-pinhole image generated by performing the process of convolving the PSF shown in FIG. 10 with the image captured by the normal camera shown in FIG. 9.

FIG. 12 is a schematic diagram showing arrangement of nine pinholes changed by affine transformation in a present third embodiment.

FIG. 13 is a schematic diagram showing one example of structure of a coded aperture camera that acquires sensor data.

### DETAILED DESCRIPTION

### Knowledge Underlying Present Disclosure

Patent Literature 1 has a problem in that, to optimize a deep learning neural network model using images captured with various measurement parameters that can be taken by a camera as input, data collection and learning require enormous costs. The measurement parameters obtained in Patent Literature 1 can be said to be optimal for a previously learned identification model. However, the identification model, which is learned in advance using images obtained by a camera with measurement parameters different from the optimal measurement parameters, has another problem in that the measurement parameters cannot be said to be optimal.

For the problem of Patent Literature 1 described above, as a method for efficiently obtaining an optimal pair of camera sensor parameters and the deep learning neural network model, Non-Patent Literature 2 and Non-Patent Literature 3, which are methods for learning sensor parameters, have been proposed.

However, in Non-Patent Literature 2, to obtain optimal chromatic aberration or astigmatism, image formation of a camera is represented by a differentiable model, but input devices that can be represented using such a differentiable model are limited. In addition, in Non-Patent Literature 2, to make the model differentiable, an approximation model that is made differentiable by approximation is used, such as a model that approximates the depth of a subject in a quantized layer structure or a model that approximates the blur that actually differs depending on the location on an image sensor as uniform. However, the method using the approximation model has a problem of reduced accuracy, and the accuracy of the method does not reach the accuracy of three-dimensional object detection using highly accurate depth information.

In addition, in Non-Patent Literature 3, the encoded exposure pattern of compressed sensing is implemented as a one-layer network, but it is difficult to implement the pattern in more complex imaging systems, such as image formation of a camera. Furthermore, the method in this literature cannot be used for devices whose model is unknown.

In other words, both Non-Patent Literature 2 and Non-Patent Literature 3 can obtain sensor parameters and identification model that improve identification ability by learning the sensor parameters simultaneously with the identification model after representing the relationship between the camera sensor parameters and the sensor data (image) using a differentiable model. However, there are many non-differentiable sensor parameters when designing or setting a camera, and the above method has a problem of not applicable to optimization of these non-differentiable sensor parameters. A method using a differentiable approximation model has also been proposed as a method for solving this problem. However, another problem may arise in that the identification performance deteriorates due to errors caused by approximation.

To solve the above problems, the following technology is disclosed.

(1) A training method according to one aspect of the present disclosure is a training method in a computer, the training method including: determining a plurality of sensor parameter candidates that are candidates for sensor parameters to be used for an operation of a sensor; generating a plurality of sensor data sets corresponding to each of the plurality of sensor parameter candidates and including sensor data to be obtained by the operation of the sensor and a plurality of pieces of correct answer identification information corresponding to each of the sensor data; generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data; calculating identification performance of the plurality of trained neural network model candidates by using another sensor data of the sensor data included in the sensor data sets and the correct answer identification information corresponding to the other sensor data; selecting a pair of the trained neural network model candidate with the highest identification performance and the sensor parameter candidate corresponding to the trained neural network model candidate with the highest identification performance; and outputting the selected pair of the sensor parameter candidate and the trained neural network model candidate.

With this configuration, the plurality of sensor parameter candidates, which is candidates for the sensor parameters used for the operation of the sensor, is determined. In addition, the plurality of trained neural network model candidates corresponding to the plurality of sensor parameter candidates is generated. The identification performance of the plurality of trained neural network model candidates is calculated, and the pair of the trained neural network model candidate with the highest identification performance and the sensor parameter candidate corresponding to the trained neural network model candidate with the highest identification performance is selected. Then, the selected pair of the sensor parameter candidate and the trained neural network model candidate is output.

Therefore, both the sensor parameters used for the operation of the sensor and the trained neural network model for identifying the target from the sensor data obtained from the sensor can be optimized. In addition, since the sensor manufactured using the sensor parameter candidates to be output and the trained neural network model candidates to be output are used for an identification system, the identification performance in the identification system can be improved.

(2) In the training method according to (1) described above, the sensor may be a multi-pinhole camera including a multi-pinhole mask in which a plurality of pinholes is formed and an image sensor, and the sensor parameters may be at least one of a distance between the multi-pinhole mask and the image sensor, a number of the plurality of pinholes, a size of each of the plurality of pinholes, and a position of each of the plurality of pinholes.

With this configuration, the multi-pinhole camera, which can acquire a captured image with intentional blur, can acquire an image in which the privacy of the subject is protected. In addition, at least one of the distance between the multi-pinhole mask and the image sensor, the number of the plurality of pinholes, the size of each of the plurality of pinholes, and the position of each of the plurality of pinholes is changed, thereby allowing images with the different degree of blur to be acquired.

(3) In the training method according to (2) described above, generating the plurality of sensor data sets may include generating the sensor data by performing a process of convolving a point spread function corresponding to the sensor parameters with the sensor data obtained by one of the pinholes.

With this configuration, the process of convolving the point spread function

corresponding to the sensor parameters with the image obtained by one pinhole is performed, thereby making it possible to generate the image with intentional blur, and acquire an image with the privacy of the subject protected as the sensor data.

(4) In the training method according to (1) described above, the sensor may be a multi-pinhole camera including a multi-pinhole mask in which a plurality of pinholes is formed and an image sensor, and the sensor parameters may be at least one of a scaling parameter, a rotation parameter, and a skew parameter for performing affine transformation on the plurality of entire pinholes.

With this configuration, positions of the plurality of pinholes can be specified using three parameters: the scaling parameter, the rotation parameter, and the skew parameter, making it possible to reduce the number of repetitions of the training operation and shorten calculation time of the training operation.

(5) In the training method according to (4) described above, generating the plurality of sensor data sets may include generating the sensor data by performing a process of convolving a point spread function on which the affine transformation is performed according to the sensor parameters with the sensor data obtained by one of the pinholes.

With this configuration, the point spread function can be easily calculated, and the plurality of sensor data corresponding to the sensor parameters can be easily generated.

(6) In the training method according to (2) described above, generating the plurality of sensor data sets may include generating the sensor data by generating a plurality of images captured from a plurality of virtual viewpoint positions based on the sensor parameters by computer graphics, and superimposing the plurality of generated images.

With this configuration, the plurality of images captured from the plurality of virtual viewpoint positions corresponding to the positions of the plurality of pinholes is generated by computer graphics, and the plurality of generated images is superimposed, thereby making it possible to generate an image with intentional blur, and acquire the image with privacy of the subject protected as the sensor data.

(7) In the training method according to any one of (1) to (6) described above, determining the plurality of sensor parameter candidates may include determining the plurality of sensor parameter candidates by black box optimization based on the plurality of sensor parameter candidates previously determined and the identification performance of the plurality of trained neural network model candidates corresponding to each of the plurality of sensor parameter candidates.

With this configuration, the new sensor parameter candidates are determined by the black box optimization based on the relationship between the plurality of sensor parameter candidates previously determined and the identification performance of the plurality of trained neural network model candidates corresponding to each of the plurality of sensor parameter candidates. Therefore, the number of repetitions of the training operation until the pair of the sensor parameter candidate with the highest identification performance and the trained neural network model candidate is obtained can be reduced.

(8) In the training method according to any one of (1) to (6) described above, determining the plurality of sensor parameter candidates may include determining the plurality of sensor parameter candidates by black box optimization based on the plurality of sensor parameter candidates previously determined, the identification performance of the plurality of trained neural network model candidates corresponding to each of the plurality of sensor parameter candidates, and an index indicating confidentiality of the sensor data.

With this configuration, the identification performance of the trained neural network model candidates is weighted with the index indicating the confidentiality of the sensor data, thereby making it possible to maintain the confidentiality of the sensor data and improve the identification performance.

(9) In the training method according to (7) or (8) described above, the black box optimization may be Bayesian estimation.

With this configuration, the Bayesian estimation makes it possible to find an optimal pair of the sensor parameter candidates and the trained neural network model candidates in a shorter time.

(10) In the training method according to (1) described above, the sensor may be a coded aperture camera including a coded mask in which a plurality of pinholes is formed and an image sensor, and the sensor parameters may be at least one of a distance between the coded mask and the image sensor, a number of the plurality of pinholes, a size of each of the plurality of pinholes, and a position of each of the plurality of pinholes.

With this configuration, the coded aperture camera, which can acquire a captured image with intentional blur, can acquire an image in which the privacy of the subject is protected. In addition, at least one of the distance between the coded mask and the image sensor, the number of the plurality of pinholes, the size of each of the plurality of pinholes, and the position of each of the plurality of pinholes is changed, thereby allowing images with the different degree of blur to be acquired.

The present disclosure can be implemented not only as the training method for performing the characteristic process as described above, but also as a training system (device) or the like having a characteristic configuration corresponding to the characteristic process performed by the training method. The characteristic process included in such a training method can also be implemented as a computer program to be executed by a computer. Therefore, the following other aspects can also produce the same effect as the above-described training method.

(11) A training system according to another aspect of the present disclosure includes: a sensor parameter candidate determination unit that determines a plurality of sensor parameter candidates that are candidates for sensor parameters to be used for an operation of a sensor; a sensor data generation unit that generates a plurality of sensor data sets corresponding to each of the plurality of sensor parameter candidates and including sensor data to be obtained by the operation of the sensor and a plurality of pieces of correct answer identification information corresponding to each of the sensor data; a neural network model training unit that generates a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data; a calculation unit that calculates identification performance of the plurality of trained neural network model candidates by using another sensor data of the sensor data included in the sensor data sets and the correct answer identification information corresponding to the other sensor data; a selection unit that selects a pair of the trained neural network model candidate with the highest identification performance and the sensor parameter candidate corresponding to the trained neural network model candidate with the highest identification performance; and an output unit that outputs the selected pair of the sensor parameter candidate and the trained neural network model candidate.

(12) A training program according to another aspect of the present disclosure causes a computer to perform functions of: determining a plurality of sensor parameter candidates that are candidates for sensor parameters to be used for an operation of a sensor; generating a plurality of sensor data sets corresponding to each of the plurality of sensor parameter candidates and including sensor data to be obtained by the operation of the sensor and a plurality of pieces of correct answer identification information corresponding to each of the sensor data; generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data; calculating identification performance of the plurality of trained neural network model candidates by using another sensor data of the sensor data included in the sensor data sets and the correct answer identification information corresponding to the other sensor data; selecting a pair of the trained neural network model candidate with the highest identification performance and the sensor parameter candidate corresponding to the trained neural network model candidate with the highest identification performance; and outputting the selected pair of the sensor parameter candidate and the trained neural network model candidate.

(13) A non-transitory computer-readable storage medium according to another aspect of the present disclosure records a training program, and the training program causes a computer to perform functions of: determining a plurality of sensor parameter candidates that are candidates for sensor parameters to be used for an operation of a sensor; generating a plurality of sensor data sets corresponding to each of the plurality of sensor parameter candidates and including sensor data to be obtained by the operation of the sensor and a plurality of pieces of correct answer identification information corresponding to each of the sensor data; generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data; calculating identification performance of the plurality of trained neural network model candidates by using another sensor data of the sensor data included in the sensor data sets and the correct answer identification information corresponding to the other sensor data; selecting a pair of the trained neural network model candidate with the highest identification performance and the sensor parameter candidate corresponding to the trained neural network model candidate with the highest identification performance; and outputting the selected pair of the sensor parameter candidate and the trained neural network model candidate.

Embodiments of the present disclosure will be described below with reference to the accompanying drawings. Note that each of the embodiments to be described below shows one specific example of the present disclosure. Numerical values, shapes, constituents, steps, order of steps, and the like shown in the embodiments below are merely one example, and are not intended to limit the present disclosure. Furthermore, a constituent that is not described in an independent claim representing the highest concept among constituents in the embodiments below is described as an arbitrary constituent. Furthermore, in all the embodiments, respective contents can be combined.

### First embodiment

A Training method, a training system, and a training program in the first embodiment of the present disclosure will be described below. The training method of the present first embodiment is also referred to as an information processing method. Meanwhile, the training system of the present first embodiment is also referred to as an information processing system.

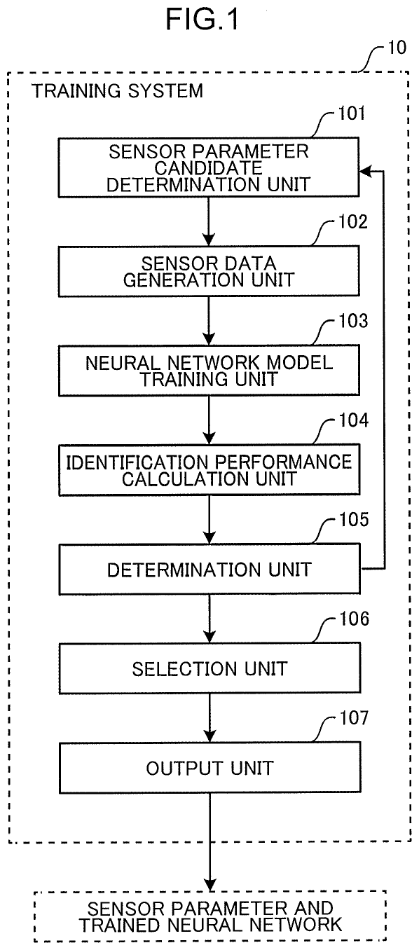

FIG. 1 is a block diagram showing one example of the configuration of the training system 10 according to the first embodiment of the present disclosure.

The training system 10 includes a microprocessor, a memory, and the like, which are not specifically illustrated. The memory includes a random access memory (RAM), a read only memory (ROM), a hard disk, and the like. The RAM, the ROM, or the hard disk stores a computer program (training program), and the microprocessor operates according to the computer program to implement functions of the training system 10. The computer program may be recorded on a computer-readable recording medium, such as an optical disc.

The training system 10 shown in FIG. 1 includes a sensor parameter candidate determination unit 101, a sensor data generation unit 102, a neural network model training unit 103, an identification performance calculation unit 104, a determination unit 105, a selection unit 106, and an output unit 107.

The sensor parameter candidate determination unit 101 determines a plurality of sensor parameter candidates, which are candidates for sensor parameters to be used for operations of a sensor 200.

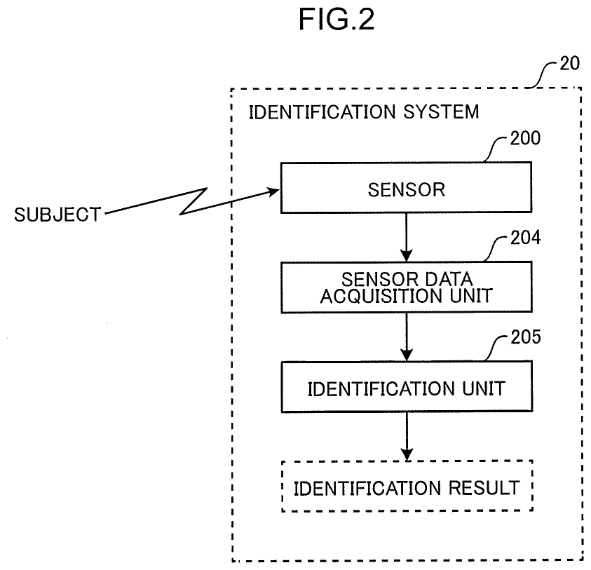

The sensor parameter candidate determination unit 101 determines the candidate values for the sensor parameters to be determined in the design or setting of the sensor 200 of the identification system 20 shown in FIG. 2 to be describe later, and outputs the determined candidate values for the sensor parameters as sensor parameter candidates.

In the present first embodiment, the sensor 200 is, for example, a multi-pinhole camera including a multi-pinhole mask in which a plurality of pinholes is formed, and an image sensor. In this case, the sensor parameters are at least one of the distance between the multi-pinhole mask and the image sensor, the number of the plurality of pinholes, the size of each of the plurality of pinholes, and the position of each of the plurality of pinholes.

When there is a plurality of sensor parameters to be determined, a plurality of candidate values for the sensor parameters will be output as the sensor parameter candidates. The candidate values for the sensor parameters that are output as the sensor parameter candidates are referred to as the sensor parameter values that are output as the sensor parameter candidates.

The sensor parameter candidate determination unit 101 outputs the sensor parameter values, which are output as the sensor parameter candidates, to the sensor data generation unit 102, which will be described later.

The sensor data generation unit 102 is a simulator that generates sensor data to be output by the sensor 200 of the identification system 20 shown in FIG. 2 described later by simulation.

The sensor data generation unit 102, for example, inputs the sensor parameter values that are output as the sensor parameter candidates, and generates a multi-pinhole image to be obtained by the operation of the multi-pinhole camera according to the sensor parameter values by simulation. In addition, the sensor data generation unit 102 generates, for example, a plurality of pairs of the multi-pinhole image corresponding to the generated sensor data and correct answer identification information (annotation information) corresponding to the multi-pinhole image, and then outputs the pairs as a plurality of sensor data sets.

The sensor data generation unit 102 generates the plurality of sensor data sets corresponding to each of the plurality of sensor parameter candidates and including the sensor data to be obtained by the operation of the sensor 200 and a plurality of pieces of the correct answer identification information corresponding to each of the sensor data.

The neural network model training unit 103 inputs the plurality of sensor data sets, trains the neural network model by using some of the plurality of sensor data sets, and outputs the neural network model obtained by training (also referred to as trained neural network model) as trained neural network model candidates.

The neural network model training unit 103 inputs some sensor data of the sensor data included in each of the plurality of sensor data sets in the neural network model corresponding to the sensor data set. The neural network model training unit 103 generates the plurality of trained neural network model candidates corresponding to the plurality of sensor parameter candidates by training the neural network model by using an error between an identification result output from the neural network model and the correct answer identification information corresponding to the some input sensor data.

In the present first embodiment, the neural network model training unit 103 trains the neural network model by using, for example, some pairs of the plurality of pairs of the multi-pinhole image and the correct answer identification information, the pairs being the plurality of sensor data sets, and outputs the trained neural network model candidates.

The identification performance calculation unit 104 inputs the plurality of sensor data sets and calculates identification performance of the trained neural network candidates by using other data sets that are not used for training of the neural network model among the plurality of input sensor data sets.

The identification performance calculation unit 104 calculates the identification performance of the plurality of trained neural network model candidates by using other sensor data of the sensor data included in the sensor data sets and the correct answer identification information corresponding to the other sensor data. For example, the identification performance is a correct answer rate of the identification result of the trained neural network model. The correct answer rate is a value obtained by dividing the number of correct answers by the number of data, and represents the proportion of the identification result of the trained neural network model that matches the correct answer identification information to other sensor data input in the trained neural network model.

In the present first embodiment, the identification performance calculation unit 104 calculates the identification performance of the trained neural network model candidates by using, for example, other pairs that are not used for the neural network model training among the plurality of pairs of the multi-pinhole image and the correct answer identification information, the other pairs being the sensor data sets.

For example, when 20,000 pairs of the sensor data and the correct answer identification information are generated, the neural network model is trained using 10,000 pairs of the sensor data and the correct answer identification information, whereas the identification performance of the trained neural network model candidates is calculated using the remaining 10,000 pairs of the sensor data and the correct answer identification information.

The determination unit 105 determines whether to continue the optimization of the sensor parameter values. That is, the determination unit 105 determines whether the identification performance of the trained neural network model candidates satisfies a termination condition. The fact that the identification performance of the trained neural network model candidates satisfies the termination condition means that the optimization of the sensor parameter values will not be continued. Meanwhile, the fact that the identification performance of the trained neural network model candidates does not satisfy the termination condition means that the optimization of the sensor parameter values will be continued. Note that the termination condition will be described later.

When the determination unit 105 determines that the optimization of the sensor parameter values will be continued, the sensor parameter candidate determination unit 101 determines new values for the sensor parameter candidates based on the evaluation of the past trained neural network model candidates, that is, the relationship between the sensor parameter values output as the sensor parameter candidates in the past, and the identification performance of the trained neural network model candidates corresponding to the values. The sensor parameter candidate determination unit 101 outputs the newly determined sensor parameter candidates. The newly output sensor parameter candidates are also referred to as new sensor parameter candidates.

The sensor parameter candidate determination unit 101 determines the plurality of sensor parameter candidates by the black box optimization based on the plurality of sensor parameter candidates previously determined and the identification performance of the plurality of trained neural network model candidates corresponding to each of the plurality of sensor parameter candidates. Note that the black box optimization is the Bayesian estimation.

The sensor data generation unit 102 inputs new sensor parameter candidates and outputs new sensor data sets. The sensor data generation unit 102 generates new sensor data based on the new sensor parameter candidates, and generates new data sets including the generated new sensor data and the plurality of pieces of correct answer identification information corresponding to each of the plurality of sensor data.

The neural network model training unit 103 inputs new sensor data sets, trains the new neural network model by using some of the new sensor data sets, and outputs new trained neural network model candidates. For the new sensor data sets, the neural network model training unit 103 inputs some new sensor data of the new sensor data included in the new sensor data sets in the new neural network model corresponding to the new sensor data sets. The neural network model training unit 103 generates the new trained neural network model candidates corresponding to the new sensor parameter candidates by training the new neural network model by using the error between the identification result output from the new neural network model and the correct answer identification information corresponding to the some new input sensor data.

The identification performance calculation unit 104 calculates the identification performance of the new trained neural network model candidates by using other new data sets that are not used for training of the new neural network model among the new sensor data sets. The identification performance calculation unit 104 calculates the identification performance of the new trained neural network model candidates by using other new sensor data of the new sensor data included in the new sensor data sets and the correct answer identification information corresponding to the other new sensor data.

The determination unit 105 determines again whether to continue the optimization of the sensor parameter values. That is, the determination unit 105 determines again whether the identification performance of the new trained neural network model candidates satisfies the termination condition. In this way, by repeating a series of operations of the sensor parameter candidate determination unit 101, the sensor data generation unit 102, the neural network model training unit 103, the identification performance calculation unit 104, and the determination unit 105, as a result, a plurality of pairs of the sensor parameter values output as the sensor parameter candidates, and the trained neural network model candidates corresponding to the values is generated.

When the determination unit 105 determines that the optimization of the sensor parameter values will not be continued, the selection unit 106 selects a pair of the sensor parameter value with the best identification performance and the trained neural network model candidate corresponding to this value. The selection unit 106 selects a pair of the trained neural network model candidate with the highest identification performance and the sensor parameter candidate corresponding to the trained neural network model candidate with the highest identification performance.

The output unit 107 outputs the sensor parameter value selected by the selection unit 106 and the trained neural network model candidate paired with the value, as the sensor parameter value with the best identification performance and the neural network model with the best identification performance. The sensor parameter value with the best identification performance may also be referred to as the optimal sensor parameter. Meanwhile, the neural network model with the best identification performance may also be referred to as the optimal neural network model. The output unit 107 outputs a pair of the sensor parameter candidate and the trained neural network model candidate selected by the selection unit 106.

FIG. 2 is a block diagram showing one example of the configuration of the identification system 20 according to the first embodiment of the present disclosure.

The identification system 20 includes a microprocessor, a memory, and the like, which are not specifically illustrated. The memory includes a RAM, a ROM, a hard disk, and the like. The RAM, the ROM, or the hard disk stores a computer program (identification program), and the microprocessor operates according to the computer program to implement functions of the identification system 20. The computer program may be recorded on a computer-readable recording medium, such as an optical disc.

The identification system 20 shown in FIG. 2 includes a sensor 200, a sensor data acquisition unit 204, and an identification unit 205.

The structure or operation of the sensor 200 is designed and configured using the sensor parameter obtained in the training system 10, that is, the sensor parameter values output from the output unit 107 with the best identification performance. The sensor 200 acquires and outputs the sensor data. The sensor with the structure or operation designed and configured using the sensor parameter values may be referred to as a sensor manufactured using the sensor parameter values.

The sensor data acquisition unit 204 acquires the sensor data obtained by the sensor 200. The sensor data acquisition unit 204 outputs the acquired sensor data to the identification unit 205.

The identification unit 205 inputs the sensor data output from the sensor 200 into the trained neural network model obtained in the training system 10, and acquires the identification result from the trained neural network model. The identification unit 205 includes the trained neural network model. The identification unit 205 outputs the identification result.

In the following description, an example will be described in which the sensor 200 is a multi-pinhole camera, the sensor data is a captured image obtained by the operation of the multi-pinhole camera (multi-pinhole image), and the sensor parameters are the focal length of the multi-pinhole camera, the number of pinholes, the size of the pinholes, and the position of the pinholes.

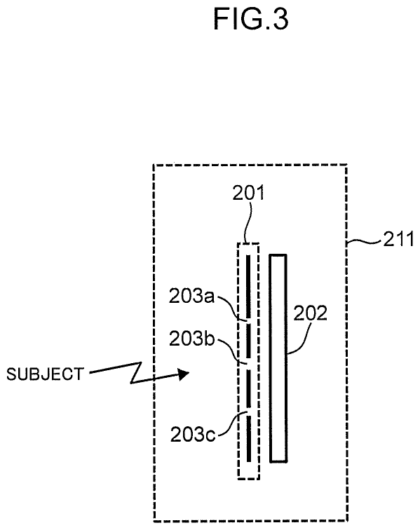

FIG. 3 is a schematic diagram showing one example of structure of a multi-pinhole camera 211 that acquires sensor data.

The multi-pinhole camera 211 is one example of the sensor 200. In the following description, the multi-pinhole camera 211, which is one example of the sensor 200, will be described. The multi-pinhole camera 211 shown in FIG. 3 includes a multi-pinhole mask 201 in which a plurality of pinholes is formed, and an image sensor 202 such as CMOS. The multi-pinhole mask 201 is disposed at a predetermined distance from the light receiving surface of the image sensor 202. The focal length of the multi-pinhole camera 211 is the distance between the multi-pinhole mask 201 and the image sensor 202. The multi-pinhole mask 201 has a plurality of pinholes 203a to 203i arranged at random or at equal intervals.

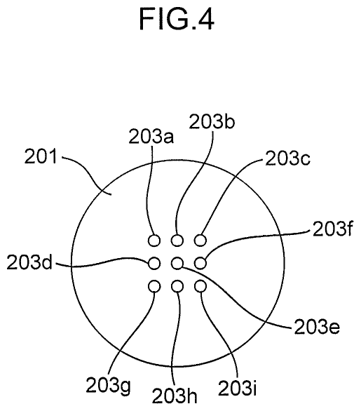

FIG. 4 is a schematic diagram showing one example of the multi-pinhole mask 201 having a plurality of pinholes.

For example, the multi-pinhole mask 201 has nine pinholes 203a to 203i. The plurality of pinholes 203a to 203i is collectively referred to as multi-pinholes. The image sensor 202 acquires an image of a subject through each of the plurality of pinholes 203a to 203i. The image acquired through one pinhole is referred to as a pinhole image.

The pinhole image of the subject differs depending on the location and size of each of the pinholes 203a to 203i. Therefore, the image sensor 202 acquires a superimposed image where a plurality of pinhole images slightly shifts and overlaps each other (multiple image). This superimposed image is referred to as a multi-pinhole image. The positional relationship of the plurality of pinholes 203a to 203i affects the positional relationship of the plurality of pinhole images projected onto the image sensor 202 (that is, degree of superimposition of multiple image). The size of each of the plurality of pinholes 203 affects the degree of blur of the corresponding pinhole image. The number of pinholes is the number of superimpositions of the pinhole image. Therefore, the number of pinholes affects the degree of blur in the captured image.

The multi-pinhole mask 201 can acquire the plurality of pinhole images that differs in position and degree of blur in a superimposed state. That is, a captured image in which the multiple image and blur are intentionally created can be acquired. Therefore, the captured image becomes a multiple image with blur, and the blur makes it possible to acquire an image in which the privacy of the subject is protected. In addition, by changing the number, position, and size of the pinholes, images with different degrees of blur can be acquired. That is, the multi-pinhole camera 211 may have a structure that allows the multi-pinhole mask 201 to be easily attached and detached according to the user's needs. A plurality of types of the multi-pinhole mask 201 with different mask patterns may be prepared in advance. The multi-pinhole camera 211 may have a configuration in which a user can freely exchange the multi-pinhole mask 201 to use.

Note that such a change in the multi-pinhole mask 201 can be implemented by any of the following methods (1) to (4), other than the replacement of the multi-pinhole mask 201.

(1) The user arbitrarily rotates the multi-pinhole mask 201, which is pivotably attached in front of the image sensor 202.

(2) The user makes a hole at an arbitrary point on a board attached in front of the image sensor 202.

(3) By using a liquid crystal mask or the like using a spatial light modulator as the multi-pinhole mask 201, the transparency at each pinhole position within the multi-pinhole mask 201 is arbitrarily set.

(4) By molding the multi-pinhole mask 201 by using a stretchable material such as rubber and physically deforming the multi-pinhole mask 201 by applying external force, the position and size of the holes are changed.

That is, the multi-pinhole image, which is a captured image obtained by the multi-pinhole camera, changes greatly, depending on the focal length value of the multi-pinhole camera, the value of the number of the plurality of pinholes, the value of the size of each of the plurality of pinholes, and the value of the position of each of the plurality of pinholes, which are each the sensor parameter value. Therefore, it is necessary to determine optimal values for these sensor parameter values. In the training system of the present first embodiment, these sensor parameter values are optimized such that the identification performance of the neural network model trained by the neural network model training unit 103 will improve. This makes it possible to obtain a pair of the optimal sensor parameter values and the neural network model.

The sensor data generation unit 102 generates the multi-pinhole image when captured by the multi-pinhole camera 211 corresponding to the plurality of sensor parameter values input as the sensor parameter candidates, and the correct answer identification information corresponding to the multi-pinhole image (annotation information). The plurality of sensor parameter values includes the focal length value of the multi-pinhole camera, the value of the number of pinholes, the pinhole size value, and the pinhole position value.

The sensor data generation unit 102 of the present first embodiment uses pre-stored data of a predetermined scene of 3D computer graphics (CG) and the correct answer identification information in the predetermined scene to generate the multi-pinhole image obtained when the multi-pinhole camera corresponding to the input sensor parameter values is placed at a plurality of predetermined virtual viewpoint positions in the scene, generate the correct answer identification information corresponding to this multi-pinhole image, and output the multi-pinhole image and the correct answer identification information.

The sensor data generation unit 102 generates a plurality of images captured from the plurality of virtual viewpoint positions by computer graphics based on the sensor parameters, and generates the sensor data by superimposing the plurality of generated images.

The correct answer identification information differs for each identification task. For example, when the identification task is object detection, the correct answer identification information is a bounding box representing a region occupied by the detection target on the image. For example, when the identification task is object identification, the classification result is the correct answer identification information. For example, when the identification task is to divide an image into regions, the region information for each pixel is the correct answer identification information. In the present first embodiment, the identification task is person detection, and as the correct answer identification information, the bounding box representing the region of the person in the multi-pinhole image is output.

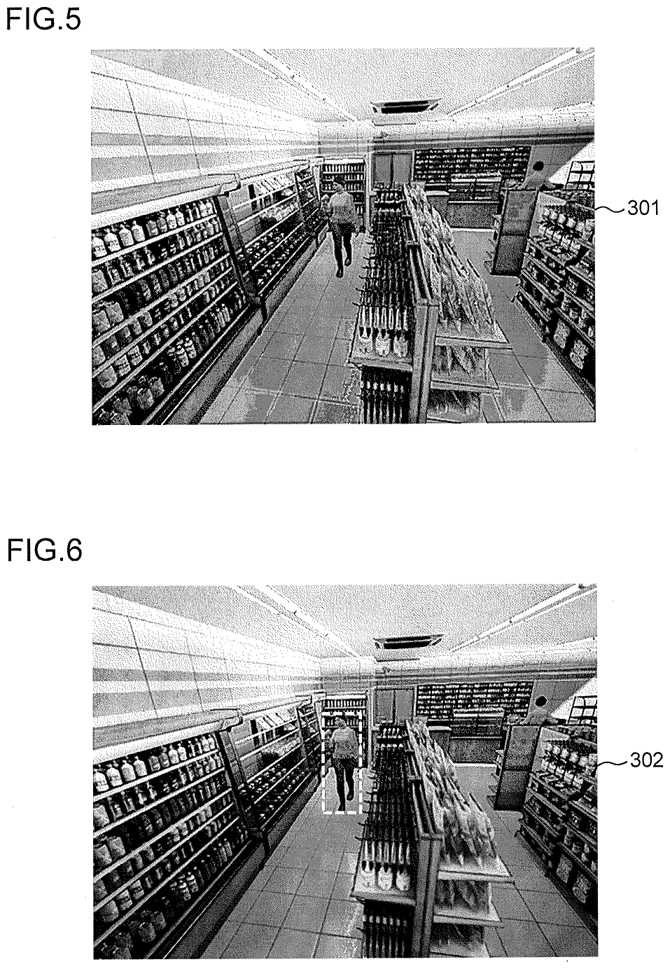

FIGS. 5 to 7 are diagrams showing one example of the multi-pinhole image generated by CG by the sensor data generation unit 102 of the first embodiment. In FIGS. 5 to 7, scenes within a real convenience store are virtually reproduced by 3D CG.

FIG. 5 is a diagram showing one example of a pinhole image 301. The pinhole image 301 shown in FIG. 5 is obtained by capturing an image of a virtual 3D scene from the virtual viewpoint position corresponding to one pinhole out of nine pinholes. As shown in FIG. 5, the pinhole image 301 captured using one pinhole is an image with almost no blur.

FIG. 6 is a diagram showing one example of a multi-pinhole image 302. The multi-pinhole image 302 shown in FIG. 6 is generated by superimposing nine sheets of the pinhole image obtained by capturing images of a virtual 3D scene from virtual viewpoint positions corresponding to nine pinholes. The white dotted rectangle in FIG. 6 represents the correct answer identification information indicating the region of a person to be detected. The correct answer identification information represents the coordinates of the rectangular bounding box on the image. As shown in FIG. 6, the multi-pinhole image 302 captured using nine pinholes is an image with blur.

The sensor data generation unit 102 generates a plurality of pinhole images obtained by capturing images of a virtual 3D scene from a plurality of virtual viewpoint positions corresponding to the plurality of pinhole positions included in the sensor parameter candidates. Then, the sensor data generation unit 102 generates one multi-pinhole image by superimposing the plurality of pinhole images to match the intervals of the plurality of pinholes.

In addition, the sensor data generation unit 102 generates the correct answer identification information corresponding to the multi-pinhole image based on the plurality of pieces of correct answer identification information corresponding to the plurality of pinhole images. When the correct answer identification information is a rectangular bounding box, the sensor data generation unit 102 superimposes the plurality of bounding boxes corresponding to the plurality of pinhole images, and generates one rectangular bounding box that includes all the superimposed bounding boxes. The sensor data generation unit 102 associates the generated multi-pinhole image with the coordinates of the generated bounding box on the image (correct answer identification information) and includes these details in the sensor data set.

The sensor data generation unit 102 repeatedly generates the plurality of pinhole images, the multi-pinhole image, and the correct answer identification information while changing the camera position in 3D space. With this operation, the sensor data generation unit 102 generates the sensor data set including the plurality of multi-pinhole images and the plurality of pieces of correct answer identification information.

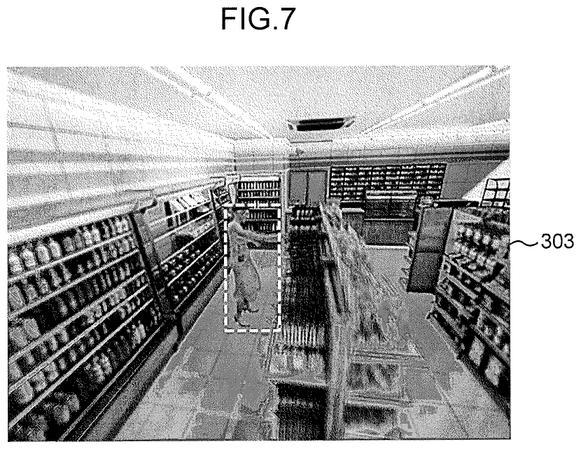

FIG. 7 is a diagram showing one example of a multi-pinhole image 303 in which the spacing between nine pinholes is wider than the spacing between nine pinholes in the multi-pinhole image 302 shown in FIG. 6. The white dotted rectangle in FIG. 7 represents the correct answer identification information indicating the region of a person to be detected. The spacing between nine pinholes of the multi-pinhole mask used to obtain the multi-pinhole image 303 shown in FIG. 7 is wider than the spacing between nine pinholes of the multi-pinhole mask used to obtain the multi-pinhole image 302 shown in FIG. 6. Therefore, the degree of blur in the multi-pinhole image 303 shown in FIG. 7 is greater than the degree of blur in the multi-pinhole image 302 shown in FIG. 6.

Note that the sensor parameter candidate determination unit 101 determines a plurality of sensor parameter candidates that differ in sensor parameters. Therefore, the sensor data generation unit 102 generates a plurality of sensor data sets corresponding to the plurality of sensor parameter candidates.

The operation of the training system 10 in the present first embodiment will be described below.

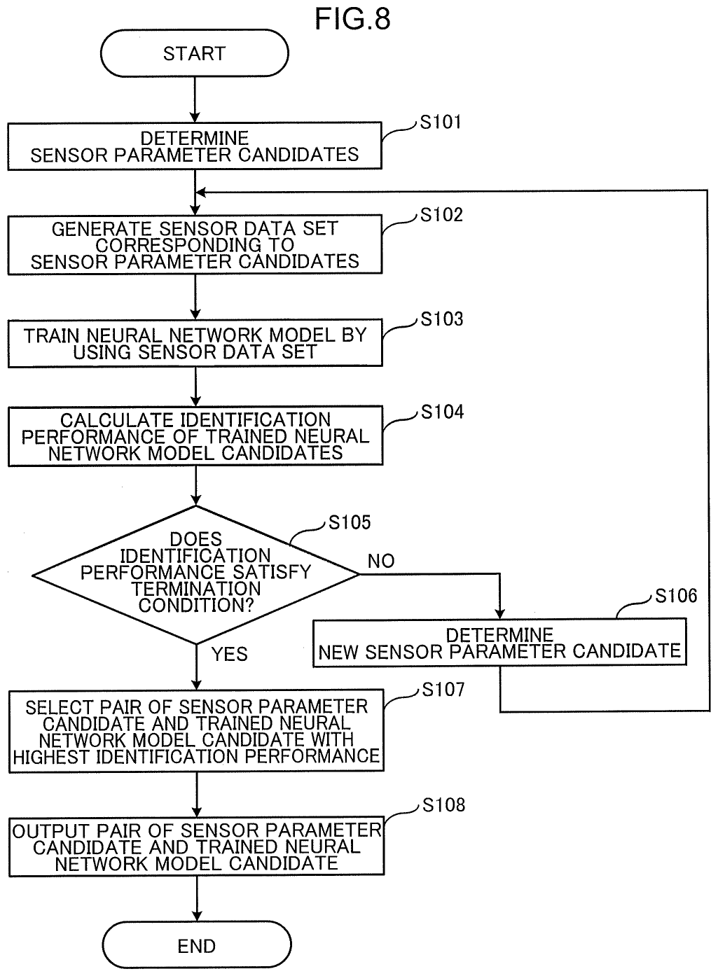

FIG. 8 is a flowchart for describing the operation of the training system 10 in the present first embodiment.

First, the sensor parameter candidate determination unit 101 determines sensor parameter candidates, which are candidates for sensor parameters to be used for the operation of the sensor 200 (step S101). The sensor parameter candidate determination unit 101 determines the focal length value, the value of the number of pinholes, the pinhole size value, and the pinhole position value, which are candidate values for the sensor parameters to be determined. The sensor parameter candidate determination unit 101 outputs these determined values as the sensor parameter candidates.

In addition, the sensor parameter candidate determination unit 101 randomly determines the value of each sensor parameter. Here, when randomly determining the sensor parameter values, the sensor parameter candidate determination unit 101 determines in advance the range that each sensor parameter value can take (that is, range determined by the maximum and minimum values), and randomly determines the value of each sensor parameter within the predetermined range.

Next, the sensor data generation unit 102 generates the sensor data set corresponding to the sensor parameter candidates determined by the sensor parameter candidate determination unit 101 and including the sensor data to be obtained by the operation of the sensor 200 and the plurality of pieces of correct answer identification information corresponding to the sensor data (step S102). The sensor data in the present first embodiment is the multi-pinhole image.

The sensor data generation unit 102 inputs each sensor parameter value that is output as the sensor parameter candidate described above. The sensor data generation unit 102 uses data of a 3D scene including a person that is saved in advance and generated using 3D computer graphics, and information on the position of the person in the 3D scene to virtually place the multi-pinhole cameras having each input sensor parameter value at a plurality of arbitrary locations in the 3D scene, and generate a plurality of pairs of the multi-pinhole image to be obtained when the multi-pinhole cameras operate, and the correct answer identification information that is information about the bounding box representing the region of the person in the image. The sensor data generation unit 102 outputs the plurality of generated pairs as the sensor data sets. For example, when the multi-pinhole cameras are placed at arbitrary M locations (M is an integer greater than or equal to 2) in the scene generated by 3D CG, the number of pairs of the multi-pinhole images and the correct answer identification information obtained when the multi-pinhole cameras operate is M (M is an integer greater than or equal to 2).

Next, the neural network model training unit 103 inputs some sensor data of the sensor data included in the sensor data set generated by the sensor data generation unit 102 into the neural network model corresponding to the sensor data set, and trains the neural network model by using an error between the identification result output from the neural network model and the correct answer identification information corresponding to the some input sensor data (step S103). By this operation, the neural network model training unit 103 generates the trained neural network model candidates corresponding to the sensor parameter candidates. The neural network model training unit 103 inputs a plurality of pairs of the multi-pinhole image and the correct answer identification information included in the sensor data set generated by the sensor data generation unit 102, and trains the neural network model by using some of the plurality of pairs as training data.

Specifically, the neural network model training unit 103 trains the neural network model such that, when inputting the multi-pinhole image of some of the plurality of pairs of the multi-pinhole image and the correct answer identification information generated according to the sensor parameter candidates into the neural network model corresponding to the input sensor data set, the correct answer identification information corresponding to the multi-pinhole image, that is, the correct answer identification information that is paired with the multi-pinhole image is output from the neural network model. Such training can be achieved, for example, by error back propagation used in deep learning, and the like.

In addition, as the neural network, any network may be used depending on each identification task. For example, CenterNet (Xingyi Zhou, Dequan Wang, Philipp Krahenbuhl, “Objects as Points”, arXiv: 1904.07850, 2019) or YOLOv4 (Alexey Bochkovskiy, Chien-Yao Wang, Hong-Yuan Mark Liao, “YOLOv4: Optimal Speed and Accuracy of Object Detection”, arXiv:2004.10934, 2020) may be used.

In step S103, the neural network model obtained through training by the neural network model training unit 103 (or also referred to as trained neural network model) may also be referred to as a neural network model candidate (or also referred to as trained neural network model candidate).

Next, the identification performance calculation unit 104 calculates the identification performance of the trained neural network model candidates by using other sensor data of the sensor data included in the sensor data sets and the correct answer identification information corresponding to the other sensor data (step S104). The identification performance calculation unit 104 calculates the identification performance of the trained neural network model candidates obtained through training of the neural network model training unit 103 by using another pair of the multi-pinhole image and the correct answer identification information that is not used in the training by the neural network model training unit 103, out of the sensor data set input into the neural network model training unit 103.

Next, the determination unit 105 determines whether the identification performance of the trained neural network model candidates calculated by the identification performance calculation unit 104 satisfies the termination condition (step S105). Here, the determination criterion for satisfying the above-mentioned termination condition is that the number of repetitions of the process from step S102 to step S106 is greater than or equal to a predetermined number of times determined in advance by the user. When the number of training sessions for the trained neural network model candidates (number of repetitions of the process from step S102 to step S106) is greater than or equal to the predetermined number of times determined in advance by the user, the determination unit 105 may determine that the identification performance satisfies the termination condition. Meanwhile, when the number of training sessions for the trained neural network model candidates is less than the predetermined number of times determined in advance by the user, the determination unit 105 may determine that the identification performance does not satisfy the termination condition.

Note that this determination criterion is not directly based on the identification performance of the neural network model candidates, but in general, the identification performance can be expected to improve as the number of training sessions increases. From this expectation, it can be expected that the predetermined identification performance will be satisfied if the number of training repetitions exceeds the predetermined number of times.

Note that the determination criterion that satisfies the termination condition may be, instead of the determination criterion mentioned above, the identification performance of the trained neural network model candidates obtained by the neural network model training unit 103 being greater than or equal to a target identification performance determined in advance by the user. When the calculated identification performance of the trained neural network model candidates is greater than or equal to the target identification performance determined in advance by the user, the determination unit 105 may determine that the identification performance satisfies the termination condition. Meanwhile, when the calculated identification performance of the trained neural network model candidates is lower than the target identification performance determined in advance by the user, the determination unit 105 may determine that the identification performance does not satisfy the termination condition.

These two determination criteria may be combined. That is, when the number of repetitions of the process from step S102 to step S106 is greater than or equal to the predetermined number of times determined in advance by the user, or when the identification performance of the trained neural network model candidates is greater than or equal to the target identification performance determined in advance by the user, the determination unit 105 may determine that the identification performance satisfies the termination condition.

When the determination unit 105 determines that the identification performance of the trained neural network model candidates does not satisfy the termination condition (NO in step S105), the sensor parameter candidate determination unit 101 determines a new sensor parameter candidate by the black box optimization, based on the plurality of sensor parameter candidates previously determined and the identification performance of the plurality of trained neural network model candidates corresponding to the plurality of sensor parameter candidates (step S106). The sensor parameter candidate determination unit 101 determines new values for the sensor parameter candidates based on evaluation of the past trained neural network model candidates, that is, the relationship between the sensor parameter values output as the sensor parameter candidates, and the identification performance of the trained neural network model candidates corresponding to the values, and outputs the new values as new sensor parameter candidates.

Here, the Bayesian estimation is used as a method for determining new values that will be new sensor parameter candidates based on the relationship between the sensor parameter values of the past trained neural network model candidates described above and the identification performance. Specifically, the sensor parameter candidate determination unit 101 predicts the relationship of the identification performance when a certain sensor parameter is given by using the Bayesian estimation based on a pair of the sensor parameter candidates and the identification performance of the trained neural network model candidates, the pair being obtained in the past training, and estimates the sensor parameter from which the identification performance better than the identification performance obtained in the past training can be expected. The sensor parameter candidate determination unit 101 determines the estimated sensor parameter as the new sensor parameter candidate.

The technique to search for optimal parameters by using the Bayesian estimation (Bayesian optimization) is widely disclosed in the following literatures and the like as a technique to search for hyperparameters in machine learning (hereinafter referred to as hyperparameter search). Therefore, detailed description will be omitted here.

James Bergstra, Remi Bardenet, Yoshua Bengio, Balazs Kegl, “Algorithms for Hyper-Parameter Optimization,” Proceedings of the 24th International Conference on Neural Information Processing Systems, December 2011, 2546-2554.

Hyperparameter search aims to search for hyperparameters that provide the best identification performance. Hyperparameter search searches for hyperparameters that provide the best identification performance by predicting the relationship between hyperparameters and the identification performance by using the Bayesian estimation while repeating the prediction of hyperparameters and the calculation of the identification performance of the model learned with the hyperparameters, and predicting new hyperparameters that can be expected to provide better identification performance.

Meanwhile, the sensor parameter candidate determination unit 101 of the present first embodiment aims to search for the sensor parameters that provide the best identification performance by applying the hyperparameter search procedure to the search for the sensor parameters. The sensor parameter candidate determination unit 101 searches for the sensor parameters that provide the best identification performance by predicting the relationship between the sensor parameters and the identification performance by using the Bayesian estimation, and predicting new sensor parameters that can be expected to provide better identification performance while repeating the prediction of the sensor parameters and the calculation of the identification performance of the trained neural network model candidates trained with the sensor parameters.

After the new the sensor parameter candidates are determined in step S106, the process returns to step S102, and the process from step S102 to step S105 is performed again.

More specifically, in step S102, the sensor data generation unit 102 inputs new sensor parameter candidates and generates and outputs a new sensor data set corresponding to the new sensor parameter candidates. Next, in step S103, the neural network model training unit 103 trains a new neural network model by using some pairs of the sensor data and the correct answer identification information included in the new sensor data set, and outputs the new trained neural network model candidates. Next, in step S104, the identification performance calculation unit 104 calculates the identification performance of the new trained neural network model candidates by using another pair of the sensor data and the correct answer identification information that is not used in the training included in the new sensor data set. Thereafter, in step S105, the determination unit 105 determines again whether the identification performance of the new trained neural network model candidates satisfy the termination condition.

In the present embodiment, an example has been described in which when the process from step S102 to step S105 is performed again after it is determined in step S105 that the identification performance does not satisfy the termination condition and the process of step S106 is performed, in the process of step S103 to be performed again, the new neural network model is trained by using some pairs of the sensor data and the correct answer identification information included in the new sensor data set generated in step S102 to be performed again. However, the present disclosure is not limited to this example.

For example, in the process of step S103 to be performed again, the trained neural network model candidates output in the previous step S103 may be trained by using some pairs of the sensor data and the correct answer identification information included in the new sensor data set generated in step S102 to be performed again. For example, in step S103 to be performed again, the identification performance of the trained neural network model candidates that is output when the trained neural network model candidates that are output by the previous process of step S103 is further trained is higher or can be expected to be higher than the identification performance of the new trained neural network model candidates described above, in step S103 to be performed again, the trained neural network model candidates that are output by the previous process of step S103 are preferably trained by using some pairs of the sensor data and the correct answer identification information included in the new sensor data set generated in step S102 to be performed again.

By repeating the process from step S102 to step S106, as a result, a plurality of pairs of the sensor parameter values that are output as the sensor parameter candidates and the trained neural network model candidates corresponding to the values is generated.

When the determination unit 105 determines that the identification performance of the trained neural network model candidates satisfies the termination condition (YES in step S105), the selection unit 106 selects the pair of the trained neural network model candidate with the highest identification performance and the sensor parameter candidate corresponding to the trained neural network model candidate with the highest identification performance (step S107). The selection unit 106 selects the pair of the sensor parameter value with the best identification performance and the trained neural network model candidate corresponding to the value.

Next, the output unit 107 outputs the pair of the sensor parameter candidate and the trained neural network model candidate selected by the selection unit 106 (step S108). The output unit 107 outputs the sensor parameter value selected by the selection unit 106 and the trained neural network model candidate paired with the value, as the sensor parameter value with the best identification performance and the neural network model with the best identification performance.

The output unit 107 outputs, on a display unit, information regarding the sensor parameter candidate among the pair of the sensor parameter candidate and the trained neural network model candidate selected by the selection unit 106. The display unit is, for example, a liquid crystal display device, and displays information regarding the sensor parameter candidate output by the output unit 107. A developer of the sensor 200 checks the displayed information about the sensor parameter candidate, and manufactures the sensor 200 based on the sensor parameter candidate.

In addition, the output unit 107 outputs the trained neural network model candidate among the pair of the sensor parameter candidate and the trained neural network model candidate selected by the selection unit 106 to the identification system 20. The memory of the identification system 20 stores the trained neural network model candidate. The identification unit 205 identifies the identification target included in the sensor data by using the trained neural network model candidate stored.

Note that the output unit 107 may store the pair of the sensor parameter candidate and the trained neural network model candidate selected by the selection unit 106 in a memory provided in the training system 10. In addition, the output unit 107 may transmit the pair of the sensor parameter candidate and the trained neural network model candidate selected by the selection unit 106 to an external terminal.

A multi-pinhole camera is manufactured with the sensor parameter values output by the output unit 107, that is, the focal length value, the value of the number of pinholes, the size value of the pinholes, and the position value of the pinhole of the multi-pinhole camera, and is used as the sensor 200 shown in FIG. 2. The trained neural network model candidate output by the output unit 107 is used as the neural network model of the identification unit 205 shown in FIG. 2.

As described above, the plurality of sensor parameter candidates, which are candidates for the sensor parameters to be used for the operation of the sensor 200, is determined. In addition, the plurality of trained neural network model candidates corresponding to the plurality of sensor parameter candidates is generated. The identification performance of the plurality of trained neural network model candidates is calculated, and the pair of the trained neural network model candidate with the highest identification performance and the sensor parameter candidate corresponding to the trained neural network model candidate with the highest identification performance is selected. Then, the selected pair of the sensor parameter candidate and the trained neural network model candidate is output.

Therefore, both the sensor parameter used for the operation of the sensor 200 and the trained neural network model for identifying the target from the sensor data obtained from the sensor 200 can be optimized. In addition, since the sensor 200 manufactured using the sensor parameter candidates to be output and the trained neural network model candidates to be output are used for the identification system 20, the identification performance in the identification system 20 can be improved.

By the operation of the training system 10 of the present first embodiment, it is possible to obtain the pair of the sensor parameter values and the trained neural network model that makes the identification performance of the identification system 20 the best. The training system 10 seeks the best sensor parameters by searching without using the gradient information or knowledge that holds between the sensor parameters and the sensor data, by so-called black box optimization, and therefore has the characteristic of being applicable to non-differentiable sensor parameters.

In addition, in the repetition of the training operation, the sensor parameter candidate determination unit 101 uses the Bayesian estimation as a technique to determine the new sensor parameter candidate, based on the evaluation of the past training operation, that is, the relationship between the sensor parameter values output as the past sensor parameter candidates and the identification performance of the trained neural network model candidates corresponding to the sensor parameter values. As a result, it can be expected that the number of repetitions of the training operation until the pair of the sensor parameter and the neural network model with the best identification performance will be reduced.

Furthermore, by configuring the identification system 20 using the sensor parameters and the trained neural network model obtained in the training system 10 of the present first embodiment, the identification system 20 has the effect that the identification performance is the best.

### Second Embodiment

In the training system 10 of the first embodiment, the sensor data generation unit 102 generates the pair of the multi-pinhole images and the correct answer identification information by using pre-saved 3D scene data including a person of 3D computer graphics and information on the position of the person in the 3D scene. However, the present disclosure is not particularly limited to this example, and may generate a pair of multi-pinhole images and correct answer identification information by using another method.

In the present second embodiment, the sensor data generation unit 102 calculates a point spread function (hereinafter referred to as PSF) generated by a multi-pinhole mask 201, the PSF corresponding to the sensor parameter values, which are input sensor parameter candidates. In addition, the sensor data generation unit 102 generates a pseudo multi-pinhole image by performing the process of convolving the PSF with an image captured by a normal camera by using a plurality of pre-saved pairs of the image captured by a normal camera and correct answer identification information. The normal camera is, for example, a camera that includes an image sensor 202 such as CMOS shown in FIG. 2 and does not include the multi-pinhole mask 201. The image captured by the normal camera is an image without blur. The sensor data generation unit 102 generates a plurality of sensor data sets including the pseudo multi-pinhole image and the correct answer identification information corresponding to the image captured by the normal camera.

The sensor data generation unit 102 may generate the sensor data by performing the process of convolving the PSF corresponding to the sensor parameters with the sensor data obtained by one pinhole. That is, the sensor data generation unit 102 may generate the pseudo multi-pinhole image by performing the process of convolving PSF corresponding to the sensor parameters with the pre-saved pinhole image captured by the pinhole camera having one pinhole.

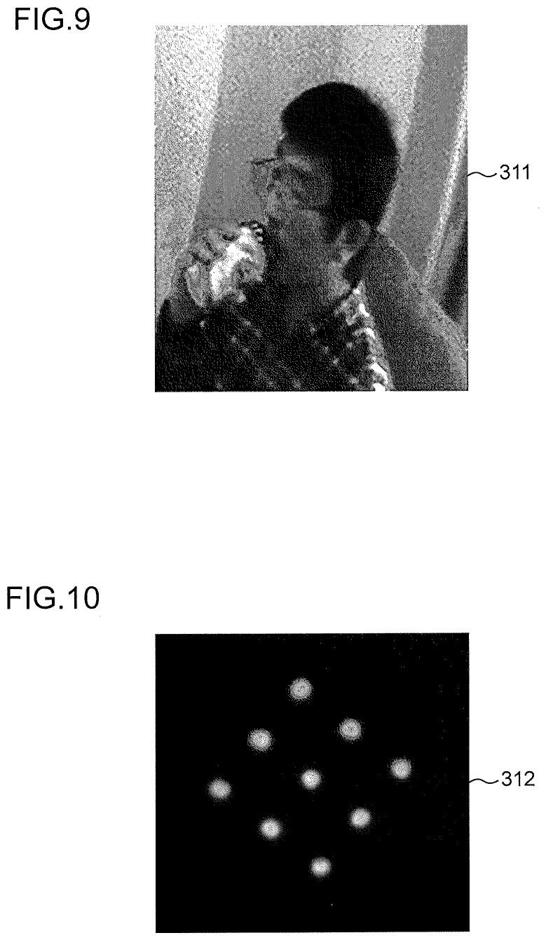

FIGS. 9 to 11 are diagrams showing one example of the pseudo multi-pinhole image generated by the sensor data generation unit 102 of the second embodiment by using the PSF.

FIG. 9 is a diagram showing one example of an image 311 captured by the normal camera. The image 311 shown in FIG. 9 is an image of a person drinking a beverage captured by the normal camera. In addition, as shown in FIG. 9, the image 311 captured by the normal camera is an image with almost no blur.

FIG. 10 is a diagram showing one example of an image 312 representing the weight of the PSF generated by a multi-pinhole mask corresponding to sensor parameter values that are input sensor parameter candidates. The sensor data generation unit 102 calculates the PSF generated by the multi-pinhole mask 201 corresponding to the sensor parameter candidates determined by the sensor parameter candidate determination unit 101.

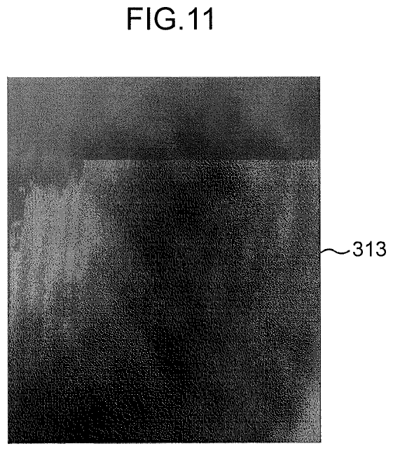

FIG. 11 is a diagram showing one example of a pseudo multi-pinhole image 313 generated by performing the process of convolving the PSF shown in FIG. 10 with the image 311 captured by a normal camera shown in FIG. 9. The sensor data generation unit 102 generates the pseudo multi-pinhole image 313, which is sensor data, by convolving the PSF representing the sensor parameters with the image 311 captured by the normal camera. As shown in FIG. 11, the pseudo multi-pinhole image 313 is an image with blur.

For example, in the multi-pinhole image obtained using the multi-pinhole camera having nine pinholes, nine pinhole images that constitute the multi-pinhole image are slightly different from each other. In contrast, the pseudo multi-pinhole camera image is different in that all nine pinhole images are the same. This difference decreases as the distance between the pinholes decreases or as the camera and the subject are far apart. Therefore, when the distance between the plurality of pinholes is small, or when the camera and the subject are far apart, the training system 10 of the present second embodiment can obtain a pair of sensor parameter values and the trained neural network model that makes the identification performance approximately the best, in a similar manner to the first embodiment.

### Third Embodiment

In the training system 10 of the first embodiment, the sensor parameters are the focal length of the multi-pinhole camera, the number of pinholes, the size of the pinholes, and the position of the pinholes, but the sensor parameters may be other parameters. In the present third embodiment, as other sensor parameters to represent the positions of the plurality of pinholes and to obtain the optimal positions of pinholes with a smaller number of parameters, the arrangement of the plurality of pinholes when the plurality of entire pinholes arranged in a square grid is moved by affine transformation is represented by affine parameters. Affine parameters are used as the sensor parameters.

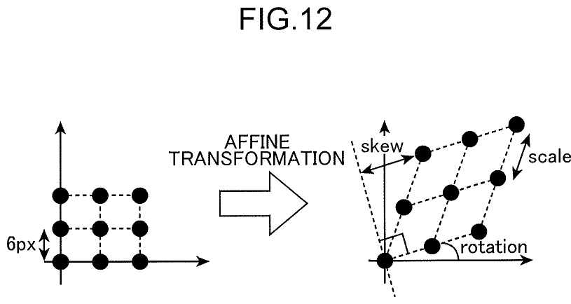

FIG. 12 is a schematic diagram showing arrangement of nine pinholes changed by affine transformation in the present third embodiment.

Affine transformation can represent two-dimensional deformation using three affine parameters: scale, rotation, and skew. The sensor parameters in the present third embodiment are at least one of the scaling parameter, rotation parameter, and skew parameter to execute affine transformation on the plurality of entire pinholes.

In the sensor parameters of the second embodiment, the position of one pinhole is represented by two values: x coordinate and y coordinate. Therefore, in the sensor parameters of the second embodiment, 18 parameters are required to represent the two-dimensional positions of nine pinholes. In contrast, in the sensor parameters of the present third embodiment, the positions of nine pinholes can be represented by three parameters of affine transformation. Therefore, when calculating the pair of the sensor parameter value and the trained neural network model that make the identification performance the best due to the operation of the training system 10, the number of repetitions of the training operation can be significantly reduced, and the calculation time of the training operation can be significantly reduced.

Note that the sensor data generation unit 102 may generate the sensor data by performing the process of convolving the PSF obtained by affine transformation according to the sensor parameters with the sensor data obtained by one pinhole. That is, the sensor data generation unit 102 may generate a pseudo multi-pinhole image by performing the process of convolving the PSF obtained by affine transformation according to the sensor parameters with the pinhole image obtained by one pinhole.

Note that the training system 10 of the first embodiment, the second embodiment, and the present third embodiment optimizes the sensor parameters and the neural network model based on the identification performance of the trained neural network model candidates. However, the optimization criterion is not limited to the identification performance, and may be another index.

The multi-pinhole image is an image created by multiplexing a plurality of pinhole images, resulting in an image with blur when viewed by a person. It can be interpreted that the greater the degree of blur, the more effective the image is for privacy protection. Meanwhile, when inputting the multi-pinhole image and performing identification by deep learning, there is a general tendency that the identification performance decrease as the degree of blur increases. In other words, there is a trade-off between the privacy protection effect and the identification performance by blur of the multi-pinhole camera.

When using the multi-pinhole camera with the above characteristics to perform identification while protecting privacy, the sensor parameters on the Pareto optimal solution, which represents the trade-off relationship between the degree of privacy protection and the identification performance, is important. To derive this Pareto optimal solution, as an optimization criterion in the sensor parameter candidate determination unit 101, a value obtained by weighting and adding an index representing the degree of blur of the multi-pinhole image to the identification performance of the trained neural network model candidates may be used as an evaluation value. Here, as an index representing the degree of blur of the multi-pinhole image, the mean squared error between one pinhole image and the multi-pinhole image may be used, or other indexes may also be used.

The sensor parameter candidate determination unit 101 may determine the plurality of sensor parameter candidates by the black box optimization based on the plurality of sensor parameter candidates previously determined, the identification performance of the plurality of trained neural network model candidates corresponding to the plurality of sensor parameter candidates, and the index indicating the confidentiality of the sensor data. The index indicating the confidentiality of the sensor data is, for example, an index indicating the degree of blur of the multi-pinhole image, and is the mean squared error between the pinhole image and the multi-pinhole image. The black box optimization is, for example, the Bayesian estimation.

### Fourth Embodiment

In the training system 10 and the identification system 20 of the first embodiment to the third embodiment, the sensor 200 is a multi-pinhole camera, but may be another sensor.

In the present fourth embodiment, the sensor 200 is a coded aperture camera with lenses.

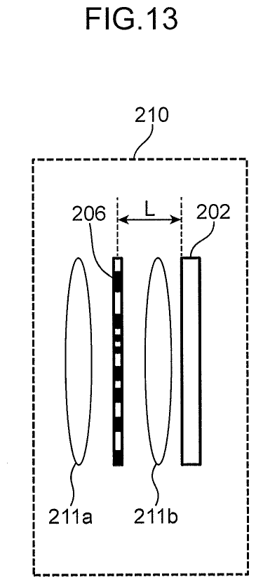

FIG. 13 is a schematic diagram showing one example of structure of a coded aperture camera 210 that acquires sensor data.

The coded aperture camera 210 is one example of the sensor 200. The coded aperture camera 210 shown in FIG. 13 includes a coded mask 206 in which a plurality of pinholes is formed, an image sensor 202 such as CMOS, and a plurality of lenses 211a to 211b. Of course, the number of lenses does not have to be two, and can be any number. The coded mask 206 is placed between the image sensor 202 and a subject. In this case, the sensor parameters are at least one of the distance L between the coded mask 206 and the image sensor 202 (shown in FIG. 13), the number of the plurality of pinholes, the size of each of the plurality of pinholes, and the position of each of the plurality of pinholes.

In the coded aperture camera 210, the coded mask 206 corresponds to a diaphragm. Therefore, the PSF indicating the degree of blur of the coded aperture camera 210 depends on the coded mask 206. For example, if the coded mask 206 has two pinholes, an image captured by the coded aperture camera 210 is a superimposed image in a state where two subjects are shifted and overlapped (multiple image) outside the in-focus position. That is, the positional relationship of the plurality of pinholes affects the positional relationship of the plurality of pinhole images projected onto the image sensor 202 (that is, degree of superimposition of multiple image). The size of each of the plurality of pinholes is the size of the diaphragm and affects the degree of blur of the pinhole image. The number of pinholes is the number of superimpositions of the pinhole image. Therefore, the number of pinholes affects the degree of blur in the captured image.

That is, the coded aperture camera 210 using the coded mask 206 can acquire the plurality of pinhole images with different positions and degrees of blur in a superimposed state by capturing the subject image that is outside the in-focus position. That is, it is possible to acquire a calculation captured image in which the multiple image and blur are intentionally created. Therefore, the captured image becomes a multiple image with blur, and the blur makes it possible to acquire an image in which the privacy of the subject is protected. In addition, by changing the values of the number, position, and size of the pinholes, images with different degrees of blur can be acquired. That is, the coded aperture camera 210 may have a structure that allows the user to easily attach and detach the coded mask 206. A plurality of types of the coded mask 206 with different mask patterns may be prepared in advance, and the coded aperture camera 210 may have a configuration that allows the user to freely exchange the coded mask 206 to use.

Note that such a change in the coded mask 206 can be implemented by any of the following methods (1) to (4), other than the replacement of the coded mask 206.

(1) The user arbitrarily rotates the coded mask 206, which is pivotably attached between the image sensor 202 and the subject.

(2) The coded mask 206 has a configuration of being inserted between the image sensor 202 and the subject. The user makes a hole at an arbitrary position in the coded mask 206.

(3) By using a liquid crystal mask using a spatial light modulator or the like as the coded mask 206, the transmittance at each pinhole position within the coded mask 206 is arbitrarily set.

(4) By molding the coded mask 206 using a stretchable material such as rubber and physically deforming the coded mask 206 by application of external force, the position and size of holes are changed.

That is, the captured image greatly changes depending on the distance L between the coded mask 206 and the image sensor 202, the number of the plurality of pinholes, the size of each of the plurality of pinholes, and the position of each of the plurality of pinholes, which are sensor parameters. Therefore, it is necessary to determine the optimal sensor parameters. In the training system 10 of the present fourth embodiment, the sensor 200 is the coded aperture camera 210 including the plurality of lenses 211a and 211b, the coded mask 206, and the image sensor 202. The sensor parameters are at least one of the distance L between the coded mask 206 and the image sensor 202, the number of the plurality of pinholes, the size of each of the plurality of pinholes, and the position of each of the plurality of pinholes. These points are different from the first embodiment.

In the present fourth embodiment, the process of obtaining the pair of the sensor parameter values with the best identification performance and the trained neural network model is the same as the process described in the first embodiment, and therefore detailed descriptions will be omitted here.

In the training system of the present fourth embodiment, these sensor parameters are optimized such that the identification performance of the neural network model trained by the neural network model training unit 103 will improve. This makes it possible to obtain the pair of the sensor parameter and the neural network model with the best identification performance.

In the first embodiment to the fourth embodiment, it is assumed that the sensor is a camera, a multi-pinhole camera, or a coded aperture camera, and the sensor data is an image, but the sensor data does not need to be an image. The sensor data may be three-dimensional image data with depth information added. Such three-dimensional image data is point cloud data or the like.

Note that in each of the above embodiments, each constituent may include dedicated hardware or may be implemented by execution of a software program suitable for each constituent. Each constituent may be implemented by a program execution unit, such as a CPU or a processor, reading and executing a software program recorded in a recording medium such as a hard disk or a semiconductor memory.

Some or all functions of the devices according to the embodiments of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiments of the present disclosure may be implemented by a processor such as a CPU executing a program.

The numerical figures used above are all illustrated to specifically describe the present disclosure, and the present disclosure is not limited to the illustrated numerical figures.

The order in which each step shown in the above flowcharts is executed is for specifically describing the present disclosure, and may be any order other than the above order as long as a similar effect is obtained. Some of the above steps may be executed simultaneously (in parallel) with other steps.

The technology according to the present disclosure can improve the identification performance. Therefore, in the identification system using machine learning or the like, the technology is useful as a technology to optimize sensor parameters used for the operation of a data input sensor such as a camera, and a neural network model for identifying data obtained from the sensor.

1. A training method, by a computer, comprising:
determining a plurality of sensor parameter candidates that are candidates for sensor parameters to be used for an operation of a sensor;
generating a plurality of sensor data sets corresponding to each of the plurality of sensor parameter candidates and including sensor data to be obtained by the operation of the sensor and a plurality of pieces of correct answer identification information corresponding to each of the sensor data;
generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data;
calculating identification performance of the plurality of trained neural network model candidates by using another sensor data of the sensor data included in the sensor data sets and the correct answer identification information corresponding to the other sensor data;
selecting a pair of the trained neural network model candidate with the highest identification performance and the sensor parameter candidate corresponding to the trained neural network model candidate with the highest identification performance; and
outputting the selected pair of the sensor parameter candidate and the trained neural network model candidate.

2. The training method according to claim 1, wherein
the sensor is a multi-pinhole camera including a multi-pinhole mask in which a plurality of pinholes is formed and an image sensor, and
the sensor parameters are at least one of a distance between the multi-pinhole mask and the image sensor, a number of the plurality of pinholes, a size of each of the plurality of pinholes, and a position of each of the plurality of pinholes.

3. The training method according to claim 2, wherein generating the plurality of sensor data sets includes generating the sensor data by performing a process of convolving a point spread function corresponding to the sensor parameters with the sensor data obtained by one of the pinholes.

4. The training method according to claim 1, wherein
the sensor is a multi-pinhole camera including a multi-pinhole mask in which a plurality of pinholes is formed and an image sensor, and
the sensor parameters are at least one of a scaling parameter, a rotation parameter, and a skew parameter for performing affine transformation on the plurality of entire pinholes.

5. The training method according to claim 4, wherein generating the plurality of sensor data sets includes generating the sensor data by performing a process of convolving a point spread function on which the affine transformation is performed according to the sensor parameters with the sensor data obtained by one of the pinholes.

6. The training method according to claim 2, wherein generating the plurality of sensor data sets includes generating the sensor data by generating a plurality of images captured from a plurality of virtual viewpoint positions based on the sensor parameters by computer graphics, and superimposing the plurality of generated images.

7. The training method according to claim 1, wherein determining the plurality of sensor parameter candidates includes determining the plurality of sensor parameter candidates by black box optimization based on the plurality of sensor parameter candidates previously determined and the identification performance of the plurality of trained neural network model candidates corresponding to each of the plurality of sensor parameter candidates.

8. The training method according to claim 1, wherein determining the plurality of sensor parameter candidates includes determining the plurality of sensor parameter candidates by black box optimization based on the plurality of sensor parameter candidates previously determined, the identification performance of the plurality of trained neural network model candidates corresponding to each of the plurality of sensor parameter candidates, and an index indicating confidentiality of the sensor data.

9. The training method according to claim 7, wherein the black box optimization is Bayesian estimation.

10. The training method according to claim 1, wherein
the sensor is a coded aperture camera including a coded mask in which a plurality of pinholes is formed and an image sensor, and
the sensor parameters are at least one of a distance between the coded mask and the image sensor, a number of the plurality of pinholes, a size of each of the plurality of pinholes, and a position of each of the plurality of pinholes.

11. A training system comprising:
a sensor parameter candidate determination unit that determines a plurality of sensor parameter candidates that are candidates for sensor parameters to be used for an operation of a sensor;
a sensor data generation unit that generates a plurality of sensor data sets corresponding to each of the plurality of sensor parameter candidates and including sensor data to be obtained by the operation of the sensor and a plurality of pieces of correct answer identification information corresponding to each of the sensor data;
a neural network model training unit that generates a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data;
a calculation unit that calculates identification performance of the plurality of trained neural network model candidates by using another sensor data of the sensor data included in the sensor data sets and the correct answer identification information corresponding to the other sensor data;
a selection unit that selects a pair of the trained neural network model candidate with the highest identification performance and the sensor parameter candidate corresponding to the trained neural network model candidate with the highest identification performance; and
an output unit that outputs the selected pair of the sensor parameter candidate and the trained neural network model candidate.

12. A non-transitory computer readable recording medium storing a training program for causing a computer to perform functions of:
determining a plurality of sensor parameter candidates that are candidates for sensor parameters to be used for an operation of a sensor;
generating a plurality of sensor data sets corresponding to each of the plurality of sensor parameter candidates and including sensor data to be obtained by the operation of the sensor and a plurality of pieces of correct answer identification information corresponding to each of the sensor data;
generating a plurality of trained neural network model candidates corresponding to the plurality of sensor parameter candidates by inputting some of the sensor data included in each of the plurality of sensor data sets into a neural network model corresponding to the sensor data set, and training the neural network model by using an error between an identification result output from the neural network model and the correct answer identification information corresponding to the input some sensor data;
calculating identification performance of the plurality of trained neural network model candidates by using another sensor data of the sensor data included in the sensor data sets and the correct answer identification information corresponding to the other sensor data;
selecting a pair of the trained neural network model candidate with the highest identification performance and the sensor parameter candidate corresponding to the trained neural network model candidate with the highest identification performance; and
outputting the selected pair of the sensor parameter candidate and the trained neural network model candidate.
